(19) United States
(12) Patent Application Publication
(10) Pub. No.: US 2019/0217551 A1
(43) Pub. Date: Jul. 18, 2019

(54) HOT-PLATE-WELDED WATER PIPE

(71) Applicant: Runner (Xiamen) Corp., Xiamen (CN)

(72) Inventors: Zhi-Quan Zhou, Xiamen (CN); Shi-Ming Zheng, Xiamen (CN); Li-Zhong Liao, Xiamen (CN)

(21) Appl. No.: 16/248,203

(22) Filed: Jan. 15, 2019

(30) Foreign Application Priority Data
Jan. 17, 2018 (CN) 201810045557.5

(51) Int. Cl. B29C 65/00; F16L 47/02; B29C 65/34; E03C 1/02

(52) U.S. Cl. CPC B29C 66/532; F16L 47/02; B29C 2045/0079; E03C 1/025; B29C 65/34

(57) ABSTRACT

A hot-plate-welded water pipe includes a first water inlet pipe, a second water inlet pipe, a lateral pipe, all of a hollow cylinder shape, and a cover plate. The lateral pipe is connected to and in communication with the first water inlet pipe and second water inlet pipe, an opening is provided on a central portion of the lateral tube, and the opening protrudes from a surface of the lateral pipe. The cover plate is connected onto the opening, and the cover plate is welded onto the opening through hot-plate-welding. The first water inlet pipe, the second water inlet pipe, and the lateral pipe formed integrally into a body through injection molding.

### BACKGROUND OF THE INVENTION

### Field of the Invention

The present invention relates to a water pipe, and in particular to a hot-plate-welded water pipe.

### The Prior Arts

Presently on the market, most of 4-inch platform water pipes are produced through a plurality of assembling processes. In general, this assembled type 4-inch platform water pipe is formed by three parts: a left pipe portion, a right pipe portion, and a lateral pipe in between. As such, in the productions process, the three parts have to be produced separately. In this situation, in case an Ejection Molding is utilized, then three molds are required to make a 4-inch platform water pipe. Finally, the three parts must be assembled and put together, to incur raised production cost, assembly time and effort. Further, in case one of the three molds utilized is damaged, the entire production process is stopped. Moreover, if the mold replacing the damaged mold is not able to match well with the other two molds, then it is possible that the other two molds have to be replaced, to cause quite a waste of molds.

Therefore, the production of this assembled type 4-inch platform water pipe is rather complicated, time consuming, and is apt to incur high cost. Since the water pipe is formed by a plurality of parts put together, and when it is damaged, replacement of parts is rather difficult. In addition, when the 4-inch platform water pipe is in use, water flows through the water pipe, and O-rings have to be used to seal the gaps between various parts, to prevent water leakage. However, the O-Ring is made of rubber, and it tends to aging to lose elasticity after long time usage. As such, the O-rings must be replaced frequently, otherwise the 4-inch platform water pipe will fail to function due to water leakage, to shorten its service life.

Therefore, presently, the design and performance of the water pipe is not quite satisfactory, and it leaves much room for improvements.

### SUMMARY OF THE INVENTION

In view of the problems and drawbacks of the prior art, the present invention provides a hot-plate-welded water pipe, that is novel in design, easy in operation, and is adapted to redress the problem of insufficient tight sealing of cover plate on the opening of a lateral pipe of the prior art.

The present invention provides a hot-plate-welded water pipe, comprising: a first water inlet pipe, a second water inlet pipe, a lateral pipe, all of a hollow cylinder shape, and a cover plate. The lateral pipe is connected to and in communication with the first water inlet pipe and second water inlet pipe, an opening is provided on a central portion of the lateral tube, and the opening protrudes from a surface of the lateral pipe. The cover plate is connected onto the opening, and the cover plate is welded onto the opening through hot-plate-welding. The first water inlet pipe, the second water inlet pipe, and the lateral pipe formed integrally into a body through injection molding.

In an aspect of the present invention, the cover plate is replaceable, and is adapted to use on various different 4-inch platform faucets, to achieve various different shapes and outer appearances.

In another aspect of the present invention, on a lower portion of a connection part between the first water inlet pipe and the lateral pipe is provided with outer threads; and on a lower portion of a connection part between the second water inlet pipe and the lateral pipe is provided with outer threads, to facilitate installation on a water basin.

In a yet another aspect of the present invention, on a pipe upper portion opening of the connection part between the first water inlet pipe and the lateral pipe is provided with inner threads and outer threads; and on a pipe upper portion opening of the connection part between the second water inlet pipe and the lateral pipe is provided with the inner threads and the outer threads.

In an aspect of the present invention, a partition piece is disposed in the first water inlet pipe, to separate the first water inlet pipe into a first water inlet channel and a first water outlet channel; and a partition piece is disposed in the second water inlet pipe, to separate the second water inlet pipe into a second water inlet channel and a second water outlet channel.

In a further aspect of the present invention, the first water inlet pipe, the second water inlet pipe, and the lateral pipe are formed into shape by means of plastic secondary molding.

Compared with the existing technology, the present invention has the following advantages:

1. The hot-plate-welded water pipe is formed by various parts integrally into a body through injection molding. Therefore, only one mold is required, without the need of additional molds or assembly steps, thus shortening the process flow;

2. The hot-plate-welded water pipe is formed by various parts integrally into a body through injection molding to achieve tight sealing. Therefore, there is no need to use sealing rings, hereby prolonging service life of the water pipe;

3. For the hot-plate-welded water pipe, the cover plate is hot-plate-welded onto the opening of the lateral pipe to achieve tight seal, so that the water pipe is more sturdy and durable; and

4. The cover plate is designed to be replaceable, and is adapted for use on various different 4-inch platform faucets to achieve various different shapes and outer appearances, to have wider scope of applications.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a hot-plate-welded water pipe according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, an embodiment is used to describe the various details of the present invention. However, it does not mean that this embodiment represents all the embodiments of the present invention. Other embodiments can be envisaged by people familiar with this field, and thus they all belong to the scope of the present invention.

In the following descriptions, the terms utilized “center”, “up”, “down”, “left”, “right”, “vertical”, “horizontal”, “in”, “out” are meant to indicate relations of orientations and positions in the attached drawings, to simplify descriptions of the present invention. Yet this does not mean expressly or implicitly the specific orientation or position of an element or a device, or it has to be operated and functions in that specific orientation or position, and thus this does not constitute restrictions of the present invention. In addition, the terms “first”, “second”, “third” are used for description purpose, and this does not mean expressly or implicitly their relative importance.

It has to be emphasized that, in the descriptions of the present invention, unless otherwise specified, the terms “install”, “communication”, “connection” should be understood in a broad sense. For example, it can be a fixed connection, a detachable connection, be connected into a body, a mechanical connection, an electric connection; a direct connection, a connection through a medium in between, and communication of inner portions of the two elements. For the people familiar with this field, the real meanings of the terms in the present invention can be understood easily and readily.

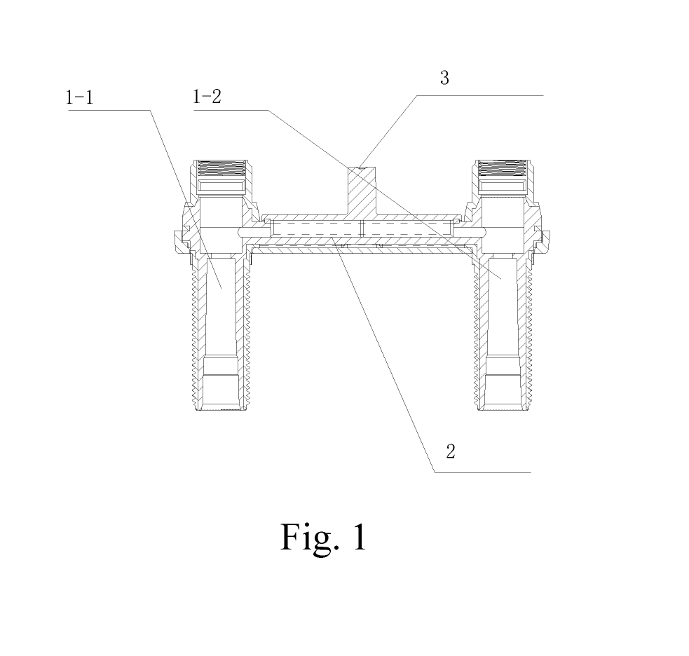

Refer to FIG. 1 for a schematic diagram of a hot-plate-welded water pipe according to the present invention. As shown in FIG. 1 the present invention provides a hot-plate-welded water pipe, comprising: a first water inlet pipe 1-1, of a hollow cylinder shape; a second water inlet pipe 1-2, of the hollow cylinder shape; a lateral pipe 2, of the hollow cylinder shape, and is connected to and in communication with the first water inlet pipe 1-1 and second water inlet pipe 1-2, an opening is provided on a central portion of the lateral tube, and the opening protrudes from a surface of the lateral pipe 2; and a cover plate 3, connected onto the opening, and the cover plate 3 is welded onto the opening through hot-plate-welding. The first water inlet pipe 1-1, the second water inlet pipe 1-2, and the lateral pipe 2 formed integrally into a body through injection molding.

In an embodiment of the present invention, the cover plate 3 is replaceable, and can be adapted to use on various different 4-inch platform faucets, to achieve various different shapes and outer appearances.

On a lower portion of a connection part between the first water inlet pipe 1-1 and the lateral pipe 2 is provided with outer threads; and on a lower portion of a connection part between the second water inlet pipe 1-2 and the lateral pipe 2 is provided with outer threads, to facilitate installation on a water basin.

On a pipe upper portion opening of the connection part between the first water inlet pipe 1-1 and the lateral pipe 2 is provided with inner threads and outer threads; and on a pipe upper portion opening of the connection part between the second water inlet pipe 1-2 and the lateral pipe 2 is provided with the inner threads and the outer threads.

A partition piece is disposed in the first water inlet pipe 1-1, to separate the first water inlet pipe 1-1 into a first water inlet channel and a first water outlet channel; a partition piece is disposed in the second water inlet pipe 1-2, to separate the second water inlet pipe 1-2 into a second water inlet channel and a second water outlet channel.

The first water inlet pipe 1-1, the second water inlet pipe 1-2, and the lateral pipe 2 are formed into shape by means of plastic secondary molding.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A hot-plate-welded water pipe, comprising:
a first water inlet pipe, of a hollow cylinder shape;
a second water inlet pipe, of the hollow cylinder shape;
a lateral pipe, of the hollow cylinder shape, wherein the lateral pipe is connected to and in communication with the first water inlet pipe and second water inlet pipe, an opening is provided on a central portion of the lateral tube, and the opening protrudes from a surface of the lateral pipe; and
a cover plate, connected onto the opening, wherein the cover plate is welded onto the opening through hot-plate-welding,
wherein the first water inlet pipe, the second water inlet pipe, and the lateral pipe are formed integrally into a body through injection molding.

2. The hot-plate-welded water pipe as claimed in claim 1, wherein the cover plate is replaceable.

3. The hot-plate-welded water pipe as claimed in claim 1, wherein on a lower portion of a connection part between the first water inlet pipe and the lateral pipe is provided with outer threads; and on a lower portion of a connection part between the second water inlet pipe and the lateral pipe is provided with outer threads.

4. The hot-plate-welded water pipe as claimed in claim 1, wherein on a pipe upper portion opening of the connection part between the first water inlet pipe and the lateral pipe is provided with inner threads and outer threads; and on a pipe upper portion opening of the connection part between the second water inlet pipe and the lateral pipe is provided with the inner threads and the outer threads.

5. The hot-plate-welded water pipe as claimed in claim 1, wherein a partition piece is disposed in the first water inlet pipe, to separate the first water inlet pipe into a first water inlet channel and a first water outlet channel; a partition piece is disposed in the second water inlet pipe, to separate the second water inlet pipe into a second water inlet channel and a second water outlet channel.

6. The hot-plate-welded water pipe as claimed in claim 1, wherein the first water inlet pipe, the second water inlet pipe, and the lateral pipe are formed into shape by means of plastic secondary molding.
